(19) United States
(12) Patent Application Publication
(10) Pub. No.: US 2009/0212560 A1
(43) Pub. Date: Aug. 27, 2009

(54) Heating System, Wind Turbine Or Wind Park, Method For Utilizing Surplus Heat Of One Or More Wind Turbine Components And Use Hereof

(75) Inventor: Gerner Larsen, Hinnerup (DK)

Correspondence Address: ST. ONGE STEWARD JOHNSTON & REENS, LLC, 986 BEDFORD STREET, STAMFORD, CT, 06905-5619, US

(73) Assignee: VESTAS WIND SYSTEMS A/S, Randers SO (DK)

(21) Appl. No.: 12/434,484

(22) Filed: May 1, 2009

Related U.S. Application Data
(63) Continuation of application No. PCT/DK2007/000477, filed on Nov. 5, 2007.

(30) Foreign Application Priority Data
Nov. 3, 2006 (DK) PA 2006 01434

(51) Int. Cl. F03D 9/00

(52) U.S. Cl. 290/2; 290/55

(57) ABSTRACT

A heating system includes at least one wind turbine, one or more wind turbine components producing surplus heat, and one or more cooling systems for removal of the surplus heat from the wind turbine components. The heating system also includes a mechanism for transporting at least a part of the surplus heat to heating processes in at least one location external to the at least one wind turbine. A wind turbine or wind park as well as a method for utilizing surplus heat of one or more wind turbine components is also contemplated. Further contemplated is use of a method for utilizing surplus heat of one or more wind turbine components in at least one wind turbine.

### CROSS-REFERENCE TO RELATED APPLICATIONS

The present application is a continuation of pending International patent application PCT/DK2007/000477 filed on Nov. 5, 2007 which designates the United States and claims priority from Danish patent application PA 2006 01434 filed on Nov. 3, 2006 the content of which is incorporated herein by reference.

### FIELD OF THE INVENTION

The invention relates to a heating system with at least one wind turbine, one or more wind turbine components producing surplus heat, and one or more cooling systems for removal of the surplus heat from the wind turbine components.

### BACKGROUND OF THE INVENTION

A modern wind turbine comprises a tower and a wind turbine nacelle positioned on top of the tower. A wind turbine rotor is connected to the nacelle through a low speed shaft, which extends out of the nacelle front. Wind over a certain level will activate the wind turbine rotor and allow it to rotate in relation to the wind. The rotation movement is converted e.g. via a gearbox to electric power by at least one electric generator. The power is usually supplied to the utility grid through electric switch gear and optionally one or more power converters as will be known by skilled persons within the area.

Even though modern wind turbines has become more and more efficient in converting the rotation of the wind turbine rotor to power, the process will always result in some of the energy being converted to heat in wind turbine components.

In order to control the temperature surplus heat must be removed from the components to protect the components and to ensure that they function properly

One way of controlling the temperature of wind turbine components is disclosed in American U.S. Pat. No. 6,676,122 B1, where a cooling system cools the components in the nacelle and the tower by circulating air inside the tower and the nacelle, making it give off heat through the surface of the tower and nacelle.

A disadvantage of the known wind turbine is the less efficiency in utilizing converted energy of the wind.

It is an object of the invention to provide technique without the above mentioned disadvantages and especially it is an object to increase the efficiency of utilized converted energy.

### SUMMARY OF THE INVENTION

The invention relates to a heating system also comprising means for transporting at least a part of said surplus heat to heating processes in at least one location external to said at least one wind turbine.

By the term “heating processes” is meant one or more processes where heat is utilized for a purpose. The heat may be utilized directly or indirectly to warm defined locations.

Hereby it is ensured that the efficiency in utilizing converted energy from the wind to energy in a wind turbine is increased due to the utilization of surplus heat produced in the wind turbine components and in the cooling system. It is still ensured that surplus heat is removed from wind turbine components which in turn ensure that the components can function properly at temperatures that are optimal.

A non-inconsiderable amount of a wind turbine power production is converted to surplus heat, especially as the size of wind turbines produced and installed are growing into mega watt size. It is therefore ensured by the present invention to provide an advantageous and cost-efficient technique for the removal and re-use of surplus heat produced whereby the efficiency of a wind turbine is increased.

Furthermore it is ensured that surplus heat can be transported to defined locations where it is optimal to utilize heat for the purpose of heating processes on locations external to a wind turbine. Defined locations can be e.g. buildings, rooms, greenhouses, fish farms etc.

In one aspect of the invention the surplus heat comprise heat produced by mechanical friction in wind turbine components such as in bearings, gear-box etc. and/or heat produced by electric wind turbine components such as electric generator, power converter, transformers and other control units etc. Hereby it is ensured that surplus heat produced in vital components of the wind turbine are removed resulting in a prolonged component lifetime and increased work efficiency. Further the mentioned components are the main contributors to the heat production of a wind turbine.

In another aspect of the invention one or more cooling systems are closed cooling circuits within or extending out of the wind turbine. Hereby it is ensured that the collected surplus heat is transferred efficiently.

In one aspect of the invention the one or more cooling systems comprise liquid coolant means. Hereby it is ensured that a medium with a high energy transport capacity is used with the result of an efficient cooling of the wind turbine components i.e. heat surplus is more efficiently collected than by other types of cooling systems.

In one aspect of the invention said one or more cooling systems comprise air-ventilation means such as generator air-ventilation means etc. Hereby is an advantageous embodiment of the invention achieved.

In a further aspect of the invention said one or more cooling systems comprise at least one heat exchanger transferring said surplus heat to said means for transporting. Hereby it is ensured that surplus heat can efficiently be transported from e.g. a primary closed-loop wind turbine liquid coolant system to a secondary closed-loop system comprising transport of heat from the heat exchanger to a distant location such as a centrally located district heating distributing central. By using an heat exchanger it is furthermore ensured that transferring of heat energy from a primary wind turbine cooling system to a secondary heating system is done by a well known and well documented way that furthermore has a high degree of efficiency.

In one aspect of the invention said means for transporting is a part of a district or teleheating system e.g. for heating residential units, buildings, rooms, etc. Hereby it is ensured that surplus heat of wind turbines is utilized on locations where needed and not wasted. Furthermore it is ensured that surplus heat is transferred to established heating systems with end-users paying for their heat consumption.

In one aspect of the invention said means for transporting is directly connected to a defined location such as one or more greenhouses. Hereby it is ensured that surplus heat is used in heating locations directly without the necessity of transferring heat from e.g. one closed-loop system to another. Installation costs may hereby be reduced.

In one aspect of the invention said wind turbine supply surplus heat in combination with heat produced by further energy sources such as a electrical heater or a dumpload system connected electrically to the wind turbine, a heat pump system, an energy system based on conventional fuels such as coal, oil and natural gas, etc. As the produced surplus energy from one or more wind turbines may vary due to e.g. alternating wind conditions, it is hereby ensured that the demand of heat or temperature of the heat to e.g. a district heating system does not rely on surplus heat from wind turbines alone, but is combined with energy sources that can controlled to supply requested amount of energy in order to fulfil said demand. Energy sources may for example be the electric generators of one or more wind turbines such as the ones also supplying surplus heat.

In another aspect of the invention, said heat pump system further moves heat from the air, such as from the internal of the wind turbine or from the outside. Hereby it is ensured that maximal heat energy for e.g. a district heating system can be produced. Furthermore it is ensured that heat energy can be produced even when the wind turbine components are not producing surplus heat or are not producing enough surplus heat.

In one aspect of the invention wherein said at least one heat exchanger is located in the wind turbine tower or in the wind turbine nacelle or in the wind turbine foundation. Hereby it is ensured that the location of a heat exchanger is optimized by position in close relation to surplus heat producing wind turbine components and in a place of a wind turbine with sufficient physical space for the heat exchanger such as in the upper- or lower part of the tower.

In another aspect of the invention, said at least one heat pump system is fully or partly located in the wind turbine tower (2) or in the wind turbine nacelle (3) or in the wind turbine foundation. Hereby it is ensured that the location of a heat pump system is optimized by position in close relation to surplus heat producing wind turbine components and in a place of a wind turbine with sufficient physical space for the heat pump system such as in the upper- or lower part of the tower.

In one aspect of the invention said at least one heat exchanger is located external to the wind turbine tower and the wind turbine nacelle such as in a container above or below the earth surface in proximity of said at least one wind turbine. Hereby it is ensured that the heat exchanger does not occupy space within the wind turbine e.g. by being positioned in a building located next to the wind turbine.

In yet another aspect of the invention, said at least one heat pump system is located external to the wind turbine tower and the wind turbine nacelle such as in a container, above or below the earth surface in proximity of said at least one wind turbine. Hereby it is ensured that the heat exchanger does not occupy space within the wind turbine e.g. by being positioned in a building located next to the wind turbine.

In one aspect of the invention said at least one wind turbine are a wind park comprising at least two wind turbines. Hereby it is ensured that more heat energy can transported from said wind park and hereby supply a larger amount of surplus heat to e.g. a large district heating system.

In another aspect of the invention said wind park comprises storage means for surplus heat accumulated from said at least two wind turbines e.g. at least one central hot-water storage tank.

In a further aspect of the invention each wind turbine comprises at least one heat exchanger and/or heat pump system, means for heat production by at least one further energy source, storage means for surplus heat accumulated from the wind turbine and/or connection and regulation means for heating of a defined location or district or tele-heating.

The invention also relates to a wind turbine or wind park as well as a method for utilizing surplus heat of one or more wind turbine components in at least one wind turbine.

Furthermore the invention also relates to use of a method for utilizing surplus heat of one or more wind turbine components in at least one wind turbine, wherein said wind turbine is a horizontal axis or vertical axis wind turbine said wind turbine is direct driven or with a gear and/or said wind turbine is a fixed speed or variable speed wind turbine. Hereby an advantageous method and use is obtained.

### BRIEF DESCRIPTION OF THE DRAWINGS

The invention will be described in the following with reference to the figures in which

FIG. 1 illustrates a large modern wind turbine including three wind turbine blades in the wind turbine rotor,

FIG. 2 illustrates schematically the principle of a cooling system for a wind turbine known in the art,

FIG. 3 illustrates schematically one embodiment of the invention, where a wind turbine cooling system is connected to an external heated system forming a closed-loop system,

FIG. 4 illustrates schematically a preferred embodiment of the invention, where a wind turbine cooling system and an external heated system is connected through a heat exchanger system,

FIG. 5 illustrates schematically the construction and function of one embodiment of a heat exchanger,

FIG. 6 illustrates schematically the construction and function of one embodiment of a heat exchanger including additional heater means, and

FIG. 7 illustrates schematically intra-connected wind turbines in a wind park and inter-connected wind parks and furthermore an additional CHP-plant.

### DETAILED DESCRIPTION OF THE INVENTION

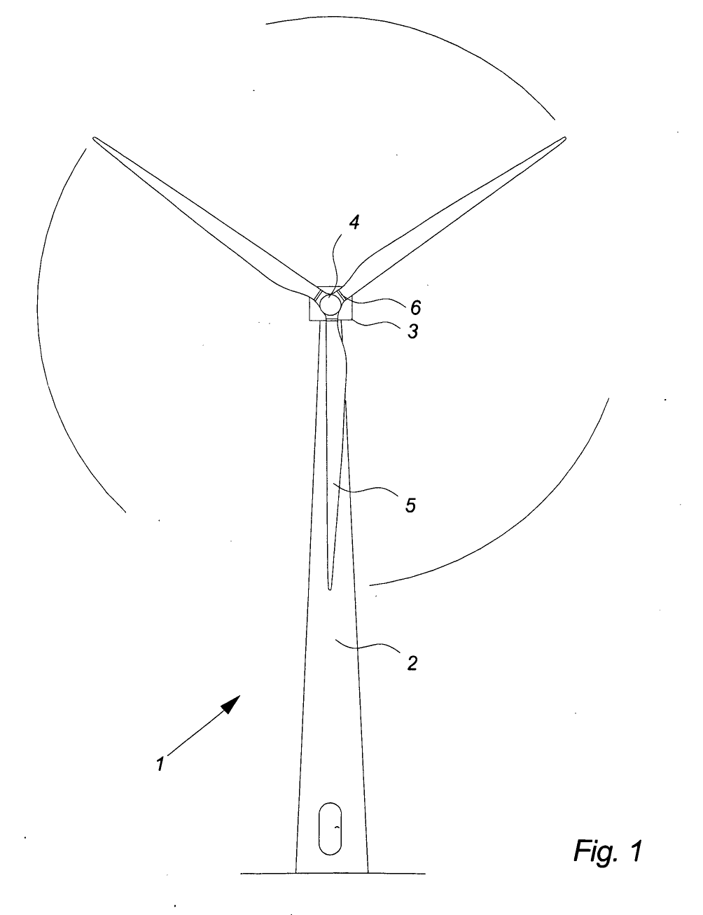

FIG. 1 illustrates a modern wind turbine 1 with a tower 2 and a wind turbine nacelle 3 positioned on top of the tower.

The wind turbine rotor, comprising at least one blade such as three wind turbine blades 5 as illustrated, is connected to the hub 4 through pitch mechanisms 6. Each pitch mechanism includes a blade bearing and pitch actuating means which allows the blade to pitch. The pitch process is controlled by a pitch controller.

As illustrated in the figure, wind over a certain level will activate the rotor and allow it to rotate. The rotation movement is converted to electric power which usually is supplied to the utility grid as will be known by skilled persons within the area.

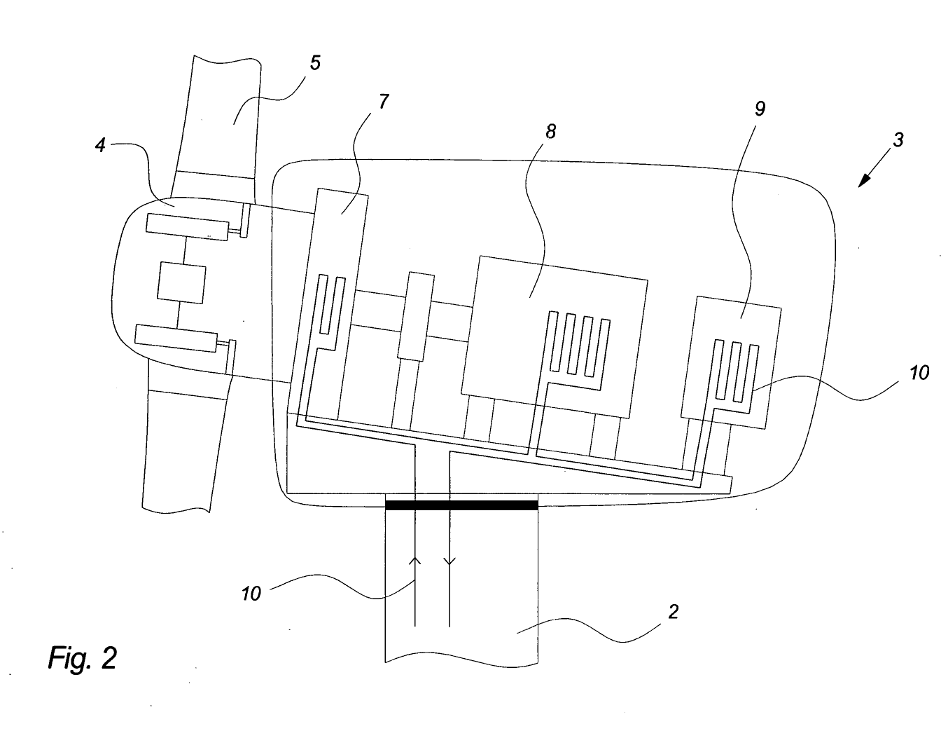

FIG. 2 illustrates schematically for one embodiment of known art, a cooling system for a wind turbine. The conversion to electric power results in surplus heat produced in various wind turbine components, e.g. generated by friction between rotating and stationary systems or produced in electrical components. The heat must be removed from the components by a wind turbine cooling system 10 to protect the components and to ensure that they function properly. Wind turbine components that produce heat during operation comprise generator 8, power electronics 7, transformers, and other control units, bearings, gear-box 7 etc.

As illustrated in the figure, surplus heat from e.g. gear-box 7, generator 8 and power electronics 9 located in the nacelle of a wind turbine, is removed by a cooling system 10 that passes through and/or around the assemblies. Traditionally cooling systems 10 leads the surplus heat via a liquid coolant to a radiator, which can give off the heat to the air outside the wind turbine and/or creating an air flow of air from the outside of the wind turbine which passes the components.

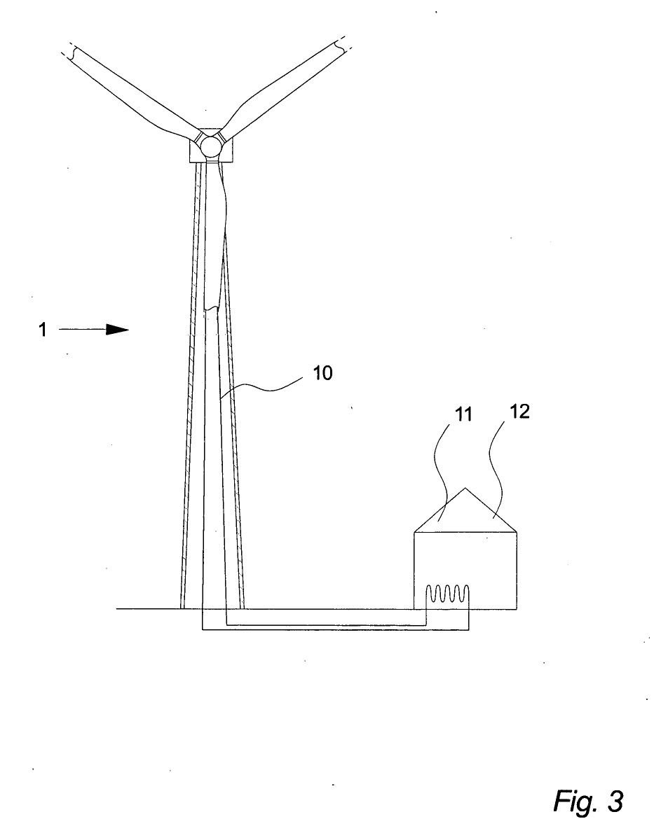

FIG. 3 illustrates schematically one embodiment of the present invention. The cooling system 10 carries surplus heat from the wind turbine components to a location external to the wind turbine 1 for the purpose of heating processes, comprising district heating of residential units, buildings, rooms etc.

As illustrated for this embodiment of the invention both the wind turbine 1 and the heated object 11 is connected to each other by one cooling system 10 i.e. surplus heat is transported directly from the wind turbine components to the location of external heating in a closed-loop system comprising cooling system components located substantially on the ground surface and/or in the ground.

In one embodiment of the invention, additional energy is added to said cooling system 10 e.g. by a heat pump that extracts heat from its ambient environment in order to raise the temperature of the surplus heat transported to the location of external heating.

In another embodiment of the invention heating processes comprise heating of greenhouses 12, fish farms etc.

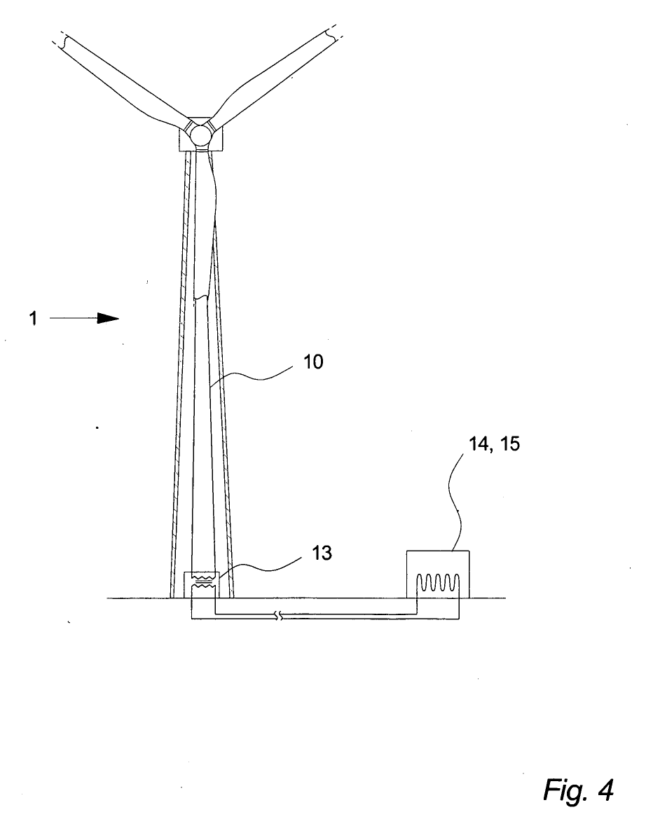

FIG. 4 illustrates a preferred embodiment of the invention, where the surplus heat from the wind turbine components is carried to a location external to the wind turbine for the purpose of heating via a heat exchanger 13 that exchanges the surplus heat carried by the cooling system 10 to an external to the wind turbine heating system 14 such as a district heating system 15. The heat exchanger 13 can be located either inside the wind turbine 1 such as in the nacelle 3 or in the tower 2 as illustrated or external to the wind turbine such as in free air or in a separate housing.

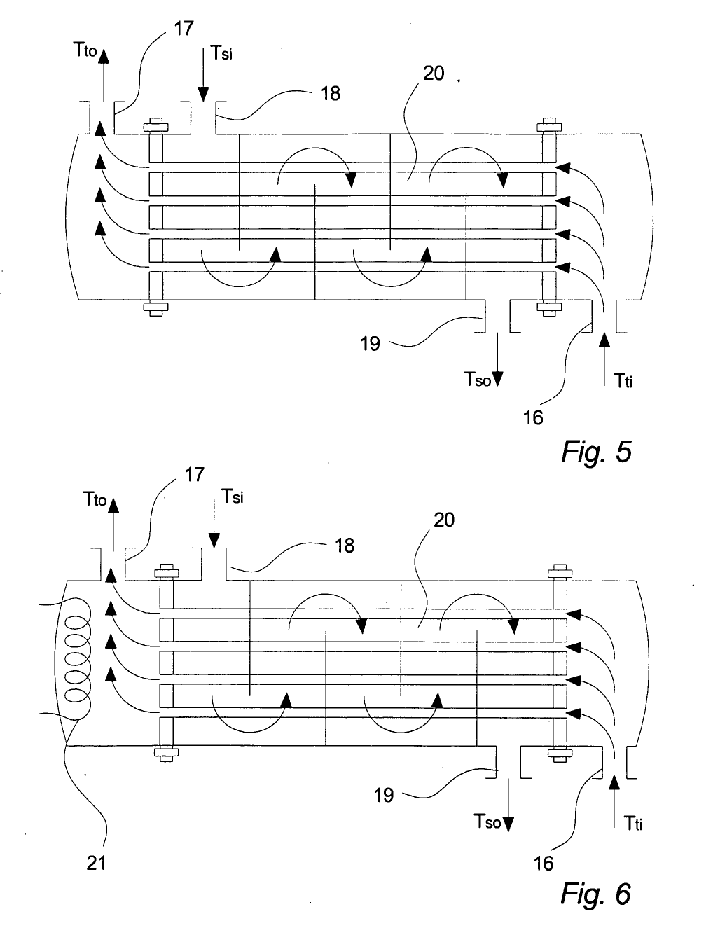

FIG. 5 illustrates schematically the construction and function of one embodiment of a heat exchanger 13 of a “one pass tube-side” straight-tube heat exchanger type, where heat is exchanged from a first liquid medium to second liquid medium, e.g. surplus heat is exchanged from an internal coolant based system 10 to an external district heating system 15.

With reference to one embodiment of the present invention, surplus heat is transported from the wind turbine components via a first liquid coolant system to the heat exchanger tube-circuit inlet 16 with a temperature Tₜᵢ. The coolant is by pressure flowing thru the heat exchanger 13 to a heat exchanger tube outlet 17 i.e. the fluid pressure at the tube inlet 16 is higher than at the tube outlet 17 whereby a fluid flow is ensured as illustrated by arrows. At the tube outlet 17 the temperature is Tₜₒ.

As an example an external district heating system 15 comprising a second liquid medium is connected to a heat exchanger shell inlet 18 with an inlet temperature Tₛᵢ. The second liquid medium is by pressure flowing thru the heat exchanger 13 to a heat exchanger shell outlet 19 i.e. the fluid pressure at the shell inlet 18 is higher than at the shell outlet 19 whereby a fluid flow is ensured as illustrated by arrows. At the shell outlet 19 the temperature is Tₛₒ.

The first and second liquid medium passes on separate sides of a system of baffles 20, utilizing a heat exchange between the first and second medium. Heat exchange is directed from the medium with the highest inlet temperature to the medium with the lowest, i.e. if the inlet temperature Tₛᵢ of the second liquid medium is lower than the inlet temperature of the first coolant Tₜᵢ, surplus heat is exchanged from the wind turbine cooling system 10 to the district heating system 15.

The amount of heat exchanged depends on the difference between the tube and shell inlet temperatures, flow speed, materials etc.

For other embodiments of the invention, the type of heat exchanger used can be of other types such as “two pass tube side” straight-tube heat exchanger, U-tube heat exchanger, plate heat exchanger etc.

For another embodiment of the invention where the surplus heat is exchanged from an internal cooling system 10 to an external district heating system 15, the district heating system 15 demands a certain temperature of the shell outlet temperature Tₛₒ in order to be able to provide a sufficient delivery of heat to district heating of e.g. residential units, buildings, rooms etc.

If the demand cannot be fulfilled e.g. due to less surplus energy produced by the wind turbine components, it might be necessary to supply additional energy from an external source to the district heating system 15.

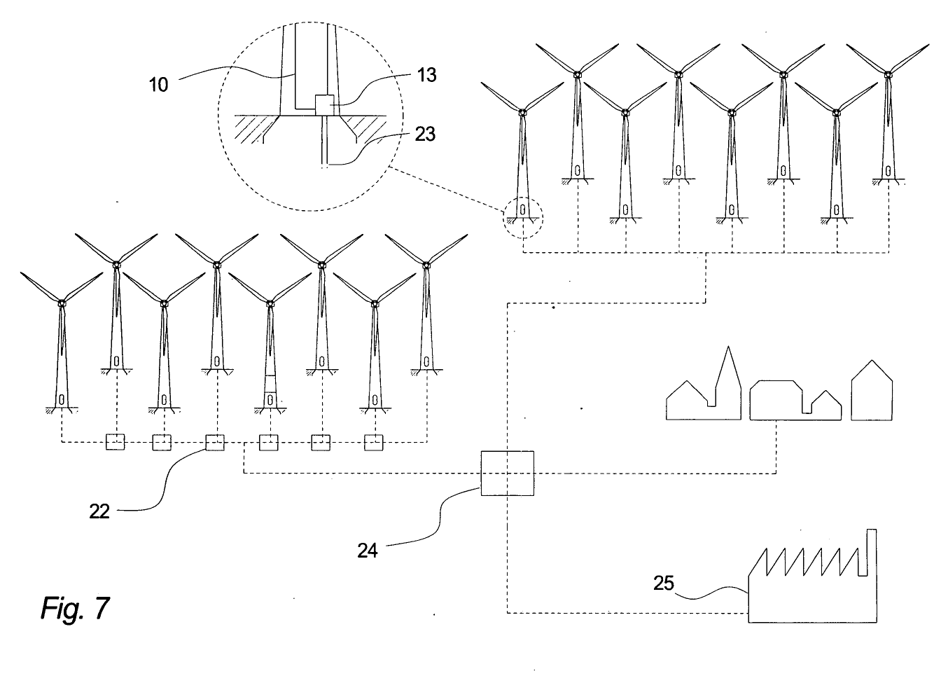

As illustrated in FIG. 6 for one embodiment of the invention, additional energy in the form of an electrical heater 21 is internally connected to the shell circuit of the heat exchanger 13 with the purpose of raising the temperature of e.g. the external district heating system 15.

In other embodiments of the invention additional energy is added to an internal cooling system 10 e.g. by a heat pump in order to raise the inlet temperature of said first coolant Tₜᵢ to said heat exchanger.

In a further embodiment of the invention, additional energy is supplied to the shell circuit external to the heat exchanger 13 such as by a heat pump.

In one embodiment of the invention the additional energy supplied to the shell circuit comes from an energy source such as the present wind turbine 1 where the heat exchanger 13 is located, solar cells, diesel generators or like.

In another embodiment of the invention the additional energy from an external source is supplied to the tube circuit of the heat exchanger 13 (not illustrated).

In one embodiment of the invention the additional energy is supplied from a dedicated wind turbine 1 that is not a part of the power production to the utility grid.

In another preferred embodiment of the invention, the surplus heat from the wind turbine components is carried to a location external to the wind turbine for the purpose of heating via a heat pump that moves heat from said wind turbine components to a higher temperature heating system external to the wind turbine, such as a district heating system.

In even further embodiments of the invention, additional heat energy can be supplied to the cooling system by one or more heat pump systems that moves heat from the air, such as from the internal of the wind turbine or from the outside, to a higher temperature heating system external to the wind turbine such as a district heating system.

In another embodiment of the invention, said one or more heat pump systems can move heat from the air, such as from the internal of the wind turbine or from the outside, to a higher temperature heating system external to the wind turbine such as a district heating system, even when the wind turbine and the wind turbine components does not produce surplus heat.

The said heat pump or heat pump systems can be located either inside the wind turbine such as in the nacelle or in the tower or external to the wind turbine such as in free air or in a separate housing.

FIG. 7 illustrates for one embodiment of the invention, a wind park comprising a least two wind turbines 1, each of them having a wind turbine cooling system 10 where surplus heat is transported from the wind turbine components to the tube-circuit in a heat exchanger 13 and/or to one or more heat pump systems. The shell-circuits 23 of the heat exchangers 13, or in the case of heat pump systems the heat sink circuits, are either directly or indirectly intra-connected through connection and regulation means 22, as to form a larger scale district heating system 15.

As illustrated on the figure, for another embodiment of the invention, two or more wind parks can be inter-connected as to form an even larger scale district heating system 15. At the interconnection point or points further connection and regulation means 24 might be necessary.

For another embodiment of the invention, also illustrated in FIG. 7, a wind park or wind parks supplied district heating system 15 can additional be connected to other types of energy source or sources, such as a combined heat-power plant (CHP-plant) 25.

In another embodiment of the invention (not illustrated) said other types of energy source or sources can be at least one heat pump connected to one or more wind parks.

In one embodiment of the invention (not illustrated), said district heating system 15 comprise energy storage means such as heat accumulator tanks in order to meet the demands of varying connected thermal load.

1. A heating system comprising
at least one wind turbine
one or more wind turbine components producing surplus heat, and
one or more cooling systems for removal of said surplus heat from said wind turbine components
characterized in that
said heating system also comprises means for transporting at least a part of said surplus heat to heating processes in at least one location external to said at least one wind turbine.

2. The heating system according to claim 1, wherein said surplus heat comprises at least one of heat produced by mechanical friction in wind turbine components and heat produced by electric wind turbine components.

3. The heating system according to claim 1, wherein said one or more cooling systems are closed cooling circuits within or extending out of said wind turbine.

4. The heating system according to claim 1, wherein said one or more cooling systems comprise liquid coolant means.

5. The heating system according to claim 1, wherein said one or more cooling systems comprise air-ventilation means.

6. The heating system according to claim 1, wherein said one or more cooling systems comprise at least one heat exchanger transferring said surplus heat to said means for transporting.

7. The heating system according to claim 1, wherein said means for transporting is a part of a district or teleheating system.

8. The heating system according to claim 1, wherein said means for transporting is directly connected to a defined location.

9. The heating system according to claim 1, wherein said wind turbine supply surplus heat in combination with heat produced by a further energy source.

10. The heating system according to claim 9, wherein said further energy source further moves heat from the air.

11. The heating system according to claim 6, wherein said at least one heat exchanger is located in the wind turbine tower or in the wind turbine nacelle or in the wind turbine foundation.

12. The heating system according to claim 9, wherein said further energy source is fully or partly located in the wind turbine tower or in the wind turbine nacelle or in the wind turbine foundation.

13. The heating system according to claim 6, wherein said at least one heat exchanger is located external to the wind turbine tower and the wind turbine nacelle.

14. The heating system according to claim 1, wherein said further energy source is located external to the wind turbine tower and the wind turbine nacelle.

15. The heating system according to claim 1, wherein said at least one wind turbine are a wind park comprising at least two wind turbines.

16. The heating system according to claim 12, wherein said wind park comprises storage means for surplus heat accumulated from said at least two wind turbines.

17. The heating system according to claim 1, wherein each wind turbine comprises at least one of the following: a heat exchanger, a heat pump system, means for heat production by at least one further energy source, storage means for surplus heat accumulated from the wind turbine, and connection and regulation means for heating of a defined location or district or teleheating.

18. A wind turbine or wind park comprising more than one turbine, said wind turbine including one or more wind turbine components producing surplus heat and one or more cooling systems for removal of said surplus heat to means for transporting at least a part of said surplus heat to heating processes in at least one location external to said wind turbine.

19. The wind turbine or wind park according to claim 18, wherein said surplus heat is transferred to said means for transporting by at least one of one or more heat exchangers and one or more heat pumps.

20. A method for utilizing surplus heat of one or more wind turbine components in at least one wind turbine at heating processes in at least one location external to said wind turbine, said method comprising steps of removing said surplus heat from said wind turbine components by one or more cooling systems (10), and transporting at least a part of said surplus heat to said heating processes in at least one location external to the wind turbine.

21. The method according to claim 20, where said surplus heat is transferred from said wind turbine cooling systems to a heat transporting system by at least one of one or more heat exchangers and one or more heat pumps.

22. Use of the method according to claim 20, wherein said wind turbine comprises at least one of a horizontal axis or vertical axis wind turbine, a wind turbine that is direct driven or provided with a gear and a wind turbine that is a fixed speed or variable speed wind turbine.
